(19) United States
(12) Patent Application Publication
(10) Pub. No.: US 2013/0180975 A1
(43) Pub. Date: Jul. 18, 2013

(54) GLOW PLUG TERMINAL AND GLOW PLUG

(71) Applicant: Yuki Okumura, Nagoya-shi (JP)

(72) Inventor: Yuki Okumura, Nagoya-shi (JP)

(73) Assignee: NGK Spark Plug Co., Ltd.

(21) Appl. No.: 13/876,523

(22) PCT Filed: Aug. 17, 2011
(86) PCT No.: PCT/JP2011/068629

§ 371 Date: Mar. 28, 2013

(30) Foreign Application Priority Data
Oct. 5, 2010 (JP) 2010-225595
Oct. 5, 2010 (JP) 2010-225599

(51) Int. Cl. H01R 13/04; F23Q 7/22

(52) U.S. Cl. CPC H01R 13/04; F23Q 7/22
USPC 219/270; 439/890

(57) ABSTRACT

A glow plug having a main body bracket, a heater, a center shaft, an insulator, an O-ring that is provided between the front end surface of the insulator and the main body bracket, and a pin terminal that is fitted to the rear end portion of the center shaft and used for supplying electricity from the outside. The pin terminal includes a small-diameter portion, a flange, and a large-diameter portion where an engagement portion and a fitting recess are formed. The large-diameter portion includes a crimp formation region, which is formed so as to have the even outer diameter and be capable of being crimped, in a range from the front end thereof to the front end of the engagement portion. A part of the crimping target portion forms a crimping portion that fixes the rear end portion of the center shaft by crimping.

### FIELD OF THE INVENTION

The present invention relates to a pin terminal for a glow plug and a glow plug.

### BACKGROUND OF THE INVENTION

JP-A-2002-260827 discloses a conventionally known glow plug. As shown in FIG. 11, the glow plug includes a cylindrical housing 90, a heater 91 that is fixed in the housing 90 and includes a heat generating portion 91a protruding from the front end of the housing 90, a rod-like center shaft 92 which is disposed in the housing 90 and includes the rear end portion protruding from the rear end of the housing 90, and a pin terminal 93 that is fitted to the rear end portion of the center shaft 92 and is used to supply electricity to the heat generating portion 91a from the outside through the center shaft 92.

The heater 91 is a ceramic heater which is fitted into an outer cylinder 94 fitted to the front end of the housing 90 and made of a conductive metal and includes the heat generating portion 91a protruding from the front end of the outer cylinder 94 and the housing 90.

The ceramic heater 91 includes a rod-like insulating body 80 that contains Si₃N₄ as a main component, a U-shaped heat generating body 81 that is embedded in the front end portion of the insulating body 80 and contains WC as a main component, a first lead wire 82 having one end connected to one end of the heat generating body 81 and the other end exposed to a part of the outer peripheral surface of the insulating body 80, and a second lead wire 83 having one end connected to the other end of the heat generating body 81 and the other end exposed to the other part of the outer peripheral surface of the insulating body 80. The other end of the first lead wire 82 itself is connected to the outer cylinder 94, the other end of the second lead wire 83 itself is connected to a current-carrying coil 95, and the current-carrying coil 95 is connected to the center shaft 92. The front end portion of the insulating body 80, in which the heat generating body 81 is embedded, is the heat generating portion 91 a of the ceramic heater 91.

The pin terminal 93 includes a small-diameter portion 93a that is formed at the rear end portion thereof and a large-diameter portion 93b that is formed at the front end portion thereof. The rear end surface of the small-diameter portion 93a has the shape of a curved surface. A first flange 93c, which comes into contact with an insulator 96 provided at the rear end portion of the housing 90 and made of an insulating material, is formed at the front end portion of the large-diameter portion 93b. Further, a second flange 93d is formed at the rear end portion of the large-diameter portion 93b, and an engagement portion 93e to which an engagement protrusion 85a of a cap 97 making current flow from the outside is locked is formed between the first and second flanges 93c and 93d.

When male threads 90a of the housing 90 are engaged with a cylinder head of a diesel engine, the heat generating portion 91 a of the ceramic heater 91 is positioned in the combustion chamber of the diesel engine. Further, the housing 90 is grounded to the cylinder head, and the cap 97 connected to a battery is fitted to the pin terminal 93. The cap 97 includes a cup-shaped cap main body 85 and a conductive member 87. The conductive member 87 is fixed by a fixing member 86, which is provided inner side of the cap main body 85, so as to extend from the inner side toward an open portion. An engagement protrusion 85a, which protrudes inward, is formed on the inner portion of the cap main body 85 close to the open portion. The conductive member 87 is connected to a lead wire 88 that is connected to a battery.

When the cap 97 is fitted to the pin terminal 93, the engagement protrusion 85a of the cap main body 85 gets over the second flange 93d and is engaged with the engagement portion 93e. In this state, the conductive member 87 comes into contact with the surface of the small-diameter portion 93a.

Accordingly, a voltage is applied between the housing 90, the outer cylinder 94 and the first lead wire 82, the pin terminal 93, the center shaft 92, and the current-carrying coil 95 and the second lead wire 83, so that the heat generating portion 91a of the ceramic heater 91 generates heat by the heat generating body 81. In so doing, the diesel engine starts.

However, the pin terminal in the related art includes the first flange formed at the front end portion of the large-diameter portion and the second flange formed at the rear end of the large-diameter portion. Accordingly, in the pin terminal, the crimp formation region, which is formed so as to have the even outer diameter and be capable of being crimped, is limited between the first and second flanges and is short. For this reason, since it is difficult to solidly join the center shaft to the pin terminal by the short crimp formation region, the joint strength between the center shaft and the pin terminal should be ensured by employing a slightly long center shaft. For this reason, in the pin terminal, the reduction in the amount of material has been insufficient and the reduction in weight has been insufficient. Further, since the glow plug also employs the pin terminal and employs a slightly long center shaft, the reduction in the amount of material is insufficient and the reduction in weight is insufficient.

### SUMMARY OF THE INVENTION

The present invention has been made in consideration of the above-mentioned circumstances. An advantage of the invention is a pin terminal that can be joined to a center shaft with high joint strength and that achieves a reduction in the amount of material and weight of a glow plug. Further, another advantage of the present invention is a glow plug that provides excellent durability through the joining between a center shaft and a pin terminal with high joint strength and can achieve a reduction in the amount of material and weight.

A pin terminal for a glow plug of the present invention comprises:

a small-diameter portion which has a shaft shape extending in an axial direction and is to be connected to a conductive member for supplying electric power from an outside;

a flange that is formed integrally with a front end of the small-diameter portion and is formed so as to have an outer diameter larger than an outer diameter of the small-diameter portion;

a cylindrical large-diameter portion that is formed integrally with a front end of the flange so as to be shorter than the small-diameter portion in the axial direction, is formed so as to have an outer diameter larger than the outer diameter of the small-diameter portion and smaller than the outer diameter of the flange, and includes a fitting recess formed therein in a radial direction so as to be recessed toward a rear end of the large-diameter portion from a front end of the large-diameter portion in the axial direction; and

an engagement portion which is positioned between a maximum diameter position of the flange and the large-diameter portion and has an outer diameter gradually reduced toward the large-diameter portion,

wherein the large-diameter portion includes a crimp formation region which is formed in a range from a front end of the large-diameter portion to a front end of the engagement portion so as to have the even outer diameter and be capable of being crimped. (claim 1)

The first flange 93c, which has been formed at the pin terminal 93 in the related art (see FIG. 11), is not formed at the pin terminal for a glow plug of the invention. Accordingly, in the pin terminal, the overall length thereof is maintained, that is, the compatibility with the cap fitted to the pin terminal is maintained and the length of the crimp formation region, which is formed so as to have the even diameter and can be crimped, is large. For this reason, the center shaft and the pin terminal are easily and solidly joined to each other at the long crimp formation region, and a slightly short center shaft can be employed. Accordingly, a reduction in the amount of material and weight can also be achieved in the pin terminal Further, since the glow plug also employs the pin terminal and a slightly short center shaft, the glow plug can achieve a reduction in the amount of material and weight.

Meanwhile, as for the operation of the first flange 93c of the pin terminal 93 in the related art (see FIG. 11), at first, it was considered that the first flange 93c can sufficiently press the insulator 96 by increasing the contact area between the first flange 93c and the rear end of the insulator 96. Further, it was considered that an O-ring (not shown) provided between the front end surface of the insulator 96 and the housing 90 is elastically deformed into a uniform shape and can improve the insulation property between the center shaft 92 and the housing 90 when the first flange 93c sufficiently presses the insulator 96. However, according to a study conducted by the inventor, as for the pin terminal 93, it was found that an insulation effect of the O-ring also can be provided since the insulator 96 can be sufficiently pressed even though the contact area between the first flange and the rear end of the insulator 96 is not increased by the first flange 93c as in the related art. That is, difference is not generated between the insulation performance of the glow plug including the pin terminal of the invention and the insulation performance of the glow plug in the related art including the pin terminal 93 on which the first flange 93c has been formed.

Accordingly, the pin terminal for a glow plug of the invention can be joined to the center shaft with high joint strength and also can achieve the reduction in the amount of material and weight of the glow plug. Since the glow plug includes the pin terminal, the glow plug provides excellent durability at a low price.

It is possible to manufacture the pin terminal for a glow plug of the invention by the plastic working or cutting of a workpiece made of conductive metal. Further, the small-diameter portion, the flange, the large-diameter portion, and the engagement portion of the pin terminal may be formed by plastic working and the fitting recess may be formed by cutting. If the pin terminal is manufactured by only the plastic working of the workpiece made of conductive metal, swarf of the workpiece is not generated during working and it is possible to achieve a reduction in manufacturing cost by saving resources. Accordingly, it is preferable that the pin terminal be manufactured by only the plastic working of the workpiece.

The fact that the crimp formation region is formed so as to have the even outer diameter does not mean that the outer diameter is exactly constant, and also includes a case where the outer diameter is not constant within a certain range, that is, the outer diameter is substantially constant as long as the crimp formation region can be crimped. Since crimping is working that is performed on a cylindrical portion having a constant outer diameter, it is not possible to perform crimping if there is a diameter difference corresponding to the first flange 93c in the related art. If a diameter difference is 0.2 mm or less, it may be considered that the outer diameter is constant in the invention.

It is preferable that a diameter of a front end surface of the large-diameter portion is smaller than that of a rear end surface of an insulating member which is a component of the glow plug. (Claim 2) In this case, it is possible to very reliably prevent current from leaking to the housing or the like from the pin terminal.

It is preferable that the fitting recess includes an inner peripheral surface that extends from the front end of the large-diameter portion toward the rear end of the large-diameter portion, and an upper bottom surface that continues to a rear end of the inner peripheral surface and is positioned inside the engagement portion or the flange in a radial direction of the engagement portion or the flange. (Claim 3) In this case, it is possible to position the rear end portion of the center shaft, which is fitted to the fitting recess, at the rear end side of the crimp formation region. For this reason, since crimping is performed at the front end side with respect to the rear end portion of the center shaft in the glow plug including the pin terminal, it is possible to more effectively prevent a load from being concentrated on the rear end portion of the center shaft. Accordingly, the durability of the center shaft itself is improved and the durability of the glow plug itself is also improved. Meanwhile, the upper bottom surface means a surface forming the upper bottom of the fitting recess and a region corresponding to a certain range that includes this surface.

According to confirmation by the inventor, when a flange is formed through plastic deformation of the workpiece, distortion or the like easily occurs on the upper bottom surface of the fitting recess formed at the workpiece by the influence of the plastic deformation. Accordingly, wrinkles and the like, which are caused by distortion, are easily formed on the upper bottom surface. Meanwhile, plating is performed on the pin terminal for a glow plug in terms of the protection of the surface of the pin terminal and the like. For this reason, if distortion occurs on the upper bottom surface, cleaning liquid and the like used in the plating remains on the wrinkles and the like of the upper bottom surface, so that the quality of the plating of the fitting recess easily deteriorates. Further, rust and the like are easily generated on the upper bottom surface by the influence of the remaining cleaning liquid and the like. For these reasons, the quality of the pin terminal easily deteriorates.

It is preferable that the upper bottom surface has a tapered shape where a diameter of the upper bottom surface is reduced toward a rear end thereof. (Claim 4) Since the upper bottom surface has a tapered shape where the diameter of the upper bottom surface is reduced toward the rear end as described above, the thickness of the periphery of the upper bottom surface of the workpiece is increased. Accordingly, it is difficult for the upper bottom surface to be deformed even by plastic deformation when the flange is formed, and it is difficult for distortion or the like to occur on the upper bottom surface. For this reason, it is difficult for cleaning liquid or the like to remain on the upper bottom surface, so that plating is preferably performed on the fitting recess. Further, it is also difficult for rust or the like to occur on the upper bottom surface. For these reasons, the pin terminal has high quality.

It is preferable that the upper bottom surface is positioned at a side of the front end of the flange with respect to the maximum diameter position of the flange. (Claim 5) The magnitude of the plastic deformation of the workpiece, when the flange is formed through plastic deformation, reaches a maximum at the maximum diameter position of the flange. For this reason, if the upper bottom surface of the fitting recess is positioned at a side of the front end with respect to the maximum diameter position of the flange, it is possible to further reduce the influence of the plastic deformation on the upper bottom surface. Accordingly, it is more difficult for the deformation of the upper bottom surface caused by plastic deformation to occur, so that the pin terminal has higher quality.

The flange may include a first cylindrical surface that is positioned close to the small-diameter portion and has a diameter larger than the diameter of the small-diameter portion, a convex curved surface which is connected to the first cylindrical surface and of which a cross-section in the axial direction forms an arc and a cross-section in a direction perpendicular to the axial direction has a circular shape, and a second cylindrical surface that is connected to the convex curved surface and has the same diameter as the diameter of the first cylindrical surface. It is preferable that a step is formed on the convex curved surface at a side of the second cylindrical surface with respect to the maximum diameter position. (Claim 6)

In this case, the cap is easily fitted to the pin terminal due to the first cylindrical surface and the convex curved surface. Further, it is difficult for the cap to be taken out from the pin terminal due to the second cylindrical surface. In this case, it is possible to preferably lock the cap to the engagement portion by using the step. For this reason, for example, even though the cap is deviated from the engagement portion due to vibration and the like and is moved in the direction where the cap is taken out from the pin terminal, the cap is caught by the step. Accordingly, the cap is preferably prevented from being moved toward the rear end from the step. Furthermore, the step itself may function as an engagement portion. Meanwhile, the step may be included in the engagement portion, and the step itself may be used as a engagement portion. In addition, the step may be simultaneously formed when the flange is formed through plastic working, and may be formed by cutting a formed flange.

It is preferable that the flange includes a cylindrical first cylindrical surface that is positioned close to the small-diameter portion and has a diameter larger than the diameter of the small-diameter portion, a convex curved surface which is connected to the first cylindrical surface and of which a cross-section in the axial direction forms an arc and a cross-section in a direction perpendicular to a shaft has a circular shape, and a cylindrical second cylindrical surface that is connected to the convex curved surface and has the same diameter as the diameter of the first cylindrical surface. (Claim 7) In this case, the cap is more easily fitted to the pin terminal due to the first cylindrical surface and the tapered surface. Further, it is difficult for the cap to be taken out from the pin terminal due to the second disc surface.

A glow plug of the present invention comprises:

a cylindrical housing;

a heater that is fixed in the housing and includes a heat generating portion protruding from a front end of the housing;

a rod-like center shaft which is disposed in the housing and includes a rear end portion protruding from a rear end of the housing;

an insulating member which is provided at the rear end of the housing and into which the center shaft is inserted; and

a pin terminal that is fitted to the rear end portion of the center shaft and used to supply an electricity to the heat generating portion from an outside through the center shaft,

wherein the pin terminal includes:
a small-diameter portion which has the shaft shape extending in an axial direction and is to be connected to a conductive member for supplying electric power from the outside;
a flange that is formed integrally with a front end of the small-diameter portion and is formed so as to have an outer diameter larger than an outer diameter of the small-diameter portion;
a cylindrical large-diameter portion that is formed integrally with a front end of the flange so as to be shorter than the small-diameter portion in the axial direction, is formed so as to have an outer diameter larger than the outer diameter of the small-diameter portion and smaller than the outer diameter of the flange, and includes a fitting recess formed therein in a radial direction so as to be recessed toward a rear end of the large-diameter portion from a front end of the large-diameter portion in the axial direction; and
an engagement portion which is positioned between a maximum diameter position of the flange and the large-diameter portion and has an outer diameter gradually reduced toward the large-diameter portion,
wherein the large-diameter portion includes a crimp formation region, which is formed in a range from a front end of the large-diameter portion to a front end of the engagement portion so as to have the even outer diameter and be capable of being crimped, and
wherein a part of the crimp formation region forms a crimping portion that fixes the rear end portion of the center shaft by crimping. (Claim 8)

The glow plug of the invention includes the pin terminal of the invention. For this reason, the glow plug provides excellent durability through the joining between the center shaft and the pin terminal with high joint strength and can achieve a reduction in the amount of material and weight. Accordingly, the glow plug provides excellent durability at a low price.

It is preferable that the crimping portion has a length that exceeds a half of an overall length of the crimp formation region in the axial direction. (Claim 9) In this case, the joint strength between the center shaft and the pin terminal is high as compared to a common product where the length of a crimping portion is equal to or smaller than the half of the overall length of a crimp formation region in the axial direction. Accordingly, the glow plug reliably provides excellent durability.

It is preferable that the crimping portion is positioned at a side of a front end of the crimp formation region with respect to a middle of the crimp formation region in the axial direction. (Claim 10) In this case, in the glow plug, crimping is performed on the pin terminal at the position that is close to the front end of the large-diameter portion. For this reason, in the glow plug, it is possible to reduce a load applied to the rear end portion of the center shaft. Accordingly, the durability of the glow plug is further improved.

The fitting recess may include an inner peripheral surface that extends from a front end of the large-diameter portion toward a rear end of the large-diameter portion, and an upper bottom surface that continues to a rear end of the inner peripheral surface and is positioned inside the engagement portion or the flange in the radial direction of the engagement portion or the flange. Further, the upper bottom surface may have a tapered shape where a diameter of the upper bottom surface is reduced toward a rear end. Furthermore, the center shaft may have a tapered rear end portion having a diameter reduced toward a rear end. Moreover, it is preferable that the rear end portion of the center shaft be positioned inside the upper bottom surface (claim 11).

In this case, since the rear end portion of the center shaft has the above-mentioned tapered shape, the rear end of the center shaft is easily inserted into the fitting recess. Further, the rear end of the center shaft inserted into the fitting recess reaches the upper bottom surface along the inner peripheral surface. In this case, since the upper bottom surface has a tapered shape where a diameter of the upper bottom surface is reduced toward the rear end, it is difficult for the upper bottom surface to be deformed even by plastic deformation as described above. Accordingly, it is difficult for distortion or the like to occur on the upper bottom surface. For this reason, since it is difficult for the fitting recess to be deformed, it is possible to preferably join the center shaft to the pin terminal with high joint strength so that the rear end portion of the center shaft is positioned inside the upper bottom surface. Furthermore, since it is difficult for distortion or the like to occur on the upper bottom surface, plating is preferably performed on the fitting recess and it is also difficult for rust or the like to occur on the upper bottom surface. For these reasons, the durability of the glow plug is further improved.

Here, the upper bottom surface means a surface forming the upper bottom of the fitting recess and a region corresponding to a certain range that includes this surface. For this reason, a fact that the rear end portion of the center shaft is positioned inside the upper bottom surface means a state where the rear end portion of the center shaft comes into contact with a surface forming the upper bottom or the rear end portion of the center shaft approaches the surface to the degree equivalent to this (see FIG. 10).

Further, it is preferable that the upper bottom surface be positioned at a side of the front end with respect to the maximum diameter position of the flange (claim 12). It is difficult for the deformation of the upper bottom surface, which is caused by plastic deformation, to occur, so that it is possible to more preferably join the center shaft to the pin terminal with high joint strength. Furthermore, since the upper bottom surface is positioned at the side of the front end with respect to the maximum diameter position of the flange as described above, the depth of the fitting recess is relatively reduced. Accordingly, it is possible to make the rear end of the center shaft short. For this reason, the whole center shaft can be formed to be short, so that it is possible to reduce the manufacturing cost of the glow plug. Meanwhile, even when the depth of the fitting recess is reduced and the rear end of the center shaft becomes short as described above, the joint strength between the center shaft and the pin terminal is maintained high since the crimping portion has a sufficient length as described above.

In the pin terminal for a glow plug of the invention and a glow plug including the pin terminal, the center shaft and the pin terminal can be joined to each other with high joint strength and a reduction in the amount of material and weight of a glow plug can be achieved. For this reason, the glow plug including the pin terminal provides excellent durability at a low price.

### BRIEF DESCRIPTION OF THE DRAWINGS

FIG. 1 is a cross-sectional view of a glow plug of an embodiment.

FIG. 2 shows a partial cross-sectional view and a partial enlarged view of a pin terminal of a glow plug of the embodiment that is not yet assembled. FIG. 2A is a partial cross-sectional view showing the entire pin terminal, and FIG. 2B is a partial enlarged view showing a convex curved surface.

FIG. 3 is an enlarged cross-sectional view showing a state where a cap and the pin terminal of the glow plug of the embodiment are fitted to each other.

FIGS. 4A to 4E show side views of a workpiece at the end of respective steps of a manufacturing method of the embodiment.

FIG. 5 is a cross-sectional view illustrating a second step of the manufacturing method of the embodiment.

FIG. 6 is a cross-sectional view illustrating a third step of the manufacturing method of the embodiment.

FIG. 7 is a cross-sectional view illustrating a fourth step of the manufacturing method of the embodiment.

FIG. 8 is a cross-sectional view showing first and second dies used in the manufacturing method of the embodiment.

FIG. 9 is a perspective view showing a punch used in the manufacturing method of the embodiment.

FIG. 10 is a partially enlarged cross-sectional view of the glow plug of the embodiment.

FIG. 11 is a partial cross-sectional view of a glow plug and the like in the related art.

### DETAILED DESCRIPTION OF PREFERRED EMBODIMENTS

An embodiment of the invention will be described below with reference to the drawings.

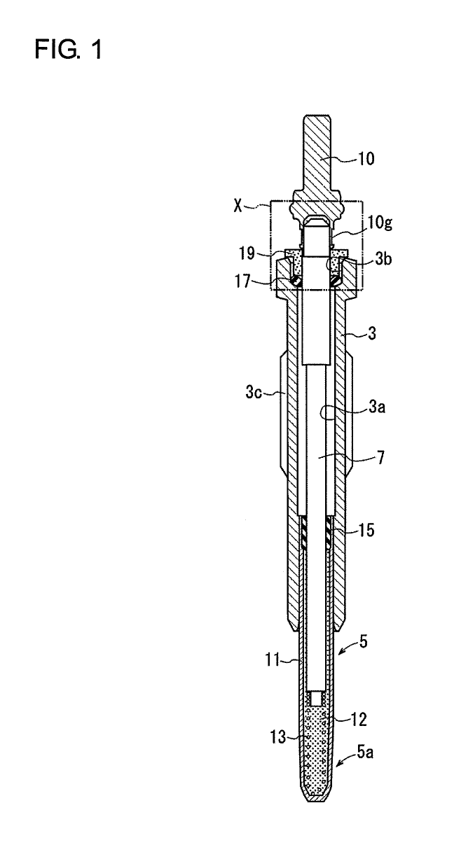

As shown in FIG. 1, a glow plug of an embodiment includes a main body bracket 3 as a cylindrical housing, a heater 5 that is fixed in the main body bracket 3 and includes a heat generating portion 5a protruding from a front end of the main body bracket 3, a rod-like center shaft 7 which is disposed in the main body bracket 3 and includes a rear end portion protruding from a rear end of the main body bracket 3, and a pin terminal 10 that is fitted to the rear end portion of the center shaft 7 and is used to apply an electricity to the heat generating portion 5a from the outside through the center shaft 7.

The heater 5 includes a heat generating tube 11 having a front end being closed. The heat generating tube 11 has the shape of a cylinder extending in the axial direction, and is fixed in the main body bracket 3 so that current can flow while a front end portion of the heat generating tube 11 protrudes from the front end portion of the main body bracket 3. A front end of the center shaft 7 is positioned in the heat generating tube 11, and a rear end of the center shaft 7 protrudes from the rear end of the main body bracket 3. Insulating powder 12 containing MgO as a main component and a heat generating coil 13 are housed in the heat generating tube 11. A front end portion of the heat generating coil 13 is joined to the front end portion of the heat generating tube 11, and a rear end portion of the heat generating coil 13 is joined to a front end portion of the center shaft 7. The heat generating tube 11, the insulating powder 12, and the heat generating coil 13 form the heater 5. Further, the front end portion of the heat generating tube 11 in which the heat generating coil 13 is housed together with the insulating powder 12 is the heat generating portion 5a of the heater 5.

An insulating body 15, which is formed of rubber packing, is fixed to the middle portion of the outer peripheral surface of the center shaft 7 and an open end of the heat generating tube 11 is crimped around the insulating body 15, so that the heat generating tube 11 is fixed to the center shaft 7 so as to be insulated from the center shaft 7.

Further, a large-diameter hole 3b of a shaft hole 3a, which has the largest diameter, is formed at the rear end portion of the main body bracket 3, and an O-ring 17 and an annular insulator 19 made of an insulating material are placed at a stepped portion that faces the rear end and is formed between the shaft hole 3a and the large-diameter hole 3b. The center shaft 7 is inserted into the respective inner peripheries of the O-ring 17 and the insulator 19. The O-ring 17 and the insulator 19 correspond to an insulating member. Meanwhile, the insulating member may be formed by integrating the O-ring 17 with the insulator 19. Further, the insulating member may be formed by the combination of three or more components, and the insulating member may be formed of a single component.

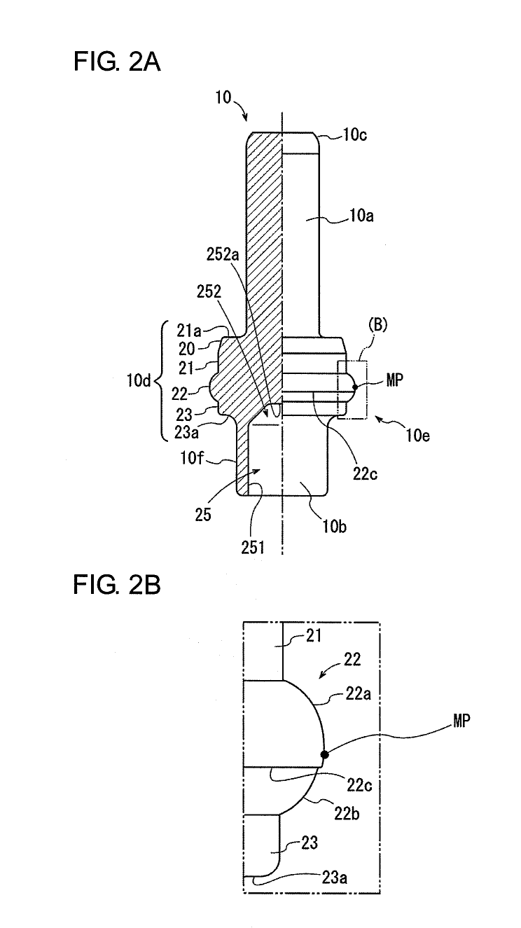

As shown in FIG. 2A, the pin terminal 10 includes a small-diameter portion 10a close to a rear end and a large-diameter portion 10b close to a front end. The small-diameter portion 10a has the shaft shape extending in the axial direction. A curved surface 10c is formed on the outer periphery of a rear end surface of the small-diameter portion 10a. Further, a flange 10d is formed between the small-diameter portion 10a and the large-diameter portion 10b. The pin terminal 10 has a shape having a diameter gradually reduced from the flange 10d toward the large-diameter portion 10b. Furthermore, the small-diameter portion 10a and the large-diameter portion 10b are separated from each other by the flange 10d.

The flange 10d includes a first cylindrical surface 21, a convex curved surface 22, and a second cylindrical surface 23. The first cylindrical surface 21 is positioned close to the small-diameter portion 10a and has the shape of a cylinder having the diameter which is larger than the diameter of the small-diameter portion 10a. The convex curved surface 22 is connected to the first cylindrical surface 21, the cross-section of the convex curved surface in the axial direction forms an arc, and the cross-section of the convex curved surface in a direction perpendicular to the axial direction has a circular shape. The second cylindrical surface 23 is connected to the convex curved surface 22, and has the shape of a cylinder having the diameter which is the same as the diameter of the first cylindrical surface 21.

In addition, the flange 10d includes a first disc surface 21a, a tapered surface 20, and a second disc surface 23a. The first disc surface 21a is connected to the small-diameter portion 10a, and extends in the direction perpendicular to the axial direction. The tapered surface 20 is connected to the first cylindrical surface 21 at the front end portion thereof, and is connected to the first disc surface 21a at the rear end portion thereof. The tapered surface 20 is formed so that the rear end portion of the tapered surface has a small diameter. The second disc surface 23a connects the second cylindrical surface 23 to the large-diameter portion 10b, and extends in the direction perpendicular to the axial direction. Meanwhile, a connecting portion between the second disc surface 23a and the large-diameter portion 10b has an arc shape. Accordingly, the second disc surface 23a and the large-diameter portion 10b are smoothly connected to each other.

Further, as shown in FIG. 2B, while a portion slightly at the side of the front end with respect to the maximum diameter position MP of the flange 10d be as a boundary, the convex curved surface 22 includes a first arc 22a that is formed toward the first cylindrical surface 21 from the portion slightly at the side of the front end with respect to the maximum diameter position MP and a second arc 22b that is formed toward the second cylindrical surface 23 from the portion slightly at the side of the front end with respect to the maximum diameter position MP. That is, a portion including the first arc 22a is the rear end portion of the convex curved surface 22, and a portion including the second arc 22b is the front end portion of the convex curved surface 22. Furthermore, a step 22c is formed at a boundary between the first arc 22a and the second arc 22b, that is, on the outer peripheral surface of the portion of the convex curved surface 22 that is slightly at the side of the front end with respect to the maximum diameter position MP. The second cylindrical surface 23 and the step 22c correspond to a engagement portion 10e. Meanwhile, the shape of the step 22c will be described in detail below.

Here, the engagement portion 10e may be formed between the maximum diameter position MP of the flange 10d and the large-diameter portion 10b, and is not limited to the second cylindrical surface 23 and the step 22c as described above. For example, the step 22c, the second cylindrical surface 23, and the second disc surface 23a may be used as the engagement portion 10e. Further, any one of the step 22c, the second cylindrical surface 23, and the second disc surface 23a may be used as the engagement portion 10e. Furthermore, the combination of the second cylindrical surface 23 and the second disc surface 23a may be used as the engagement portion 10e.

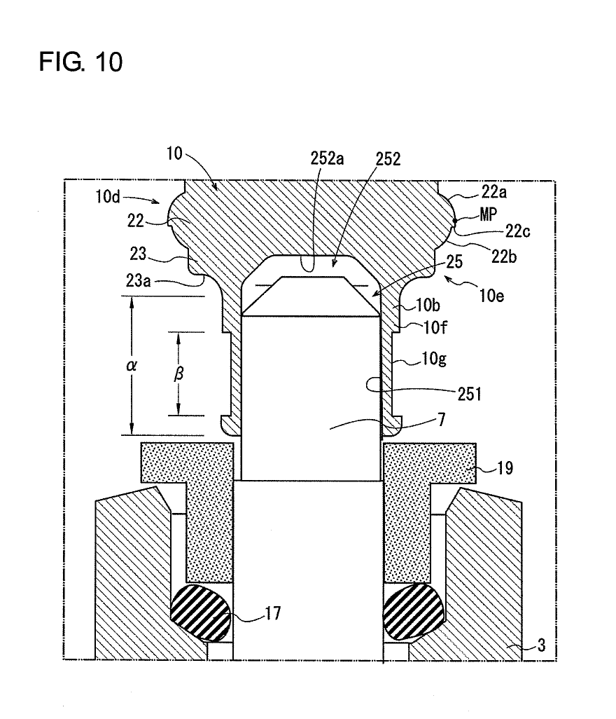

As shown in FIG. 2A, the large-diameter portion 10b is formed integrally with the front end of the small-diameter portion 10a and is formed so as to have an outer diameter larger than the outer diameter of the small-diameter portion 10a and smaller than the outer diameter of the flange 10d. Further, the diameter of the front end surface of the large-diameter portion 10b is smaller than the diameter of the rear end surface of the insulator 19 (see FIG. 10) to be described below.

Furthermore, in the pin terminal 10 which is not yet assembled, a range of from the front end of the large-diameter portion 10b to the front end of the engagement portion 10e have substantially the even outer diameter since being formed so as to have a diameter difference of 0.2 mm or less. Moreover, this range is a crimp formation region 10f.

In addition, a fitting recess 25 into which the center shaft 7 is fitted is formed at the front end surface of the large-diameter portion 10b. The fitting recess 25 includes an inner peripheral surface 251 and an upper bottom surface 252 that are formed in the pin terminal 10. The inner peripheral surface 251 extends from the front end of the large-diameter portion 10b toward the rear end of the large-diameter portion, and the upper bottom surface 252 continues to the rear end of the inner peripheral surface 251 and is positioned inside the flange 10d in the radial direction. The upper bottom surface 252 is a surface 252a forming the upper bottom of the fitting recess 25 and a region corresponding to a certain range that includes the surface 252a. Further, the upper bottom surface 252 has a tapered shape where the diameter of the upper bottom surface is reduced from the front end of the pin terminal 10 toward the rear end. Furthermore, the upper bottom surface 252 is positioned in the pin terminal 10 at the side of the front end with respect to the maximum diameter position MP of the flange 10d, more specifically, is positioned in the pin terminal 10 at a position corresponding to the second cylindrical surface 23.

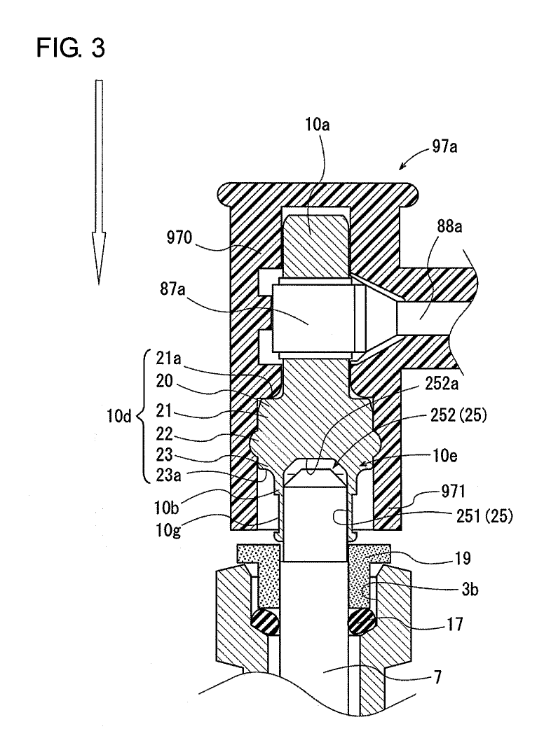

A cap 97a, which is used to apply an electricity to the pin terminal from the outside, is mounted on the pin terminal 10 as shown in FIG. 3. The cap 97a includes a cup-shaped cap main body 970 and a conductive member 87a that is fixed to the back side of the cap main body 970. The cap main body 970 is made of a resin. Further, a portion 971 to be locked is formed on the inside of the open portion of the cap main body 970. Meanwhile, the conductive member 87a is connected to a lead wire 88a that is connected to a battery (not shown).

In the manufacture of the glow plug, the pin terminal 10 is manufactured by the following respective steps.

### First Step

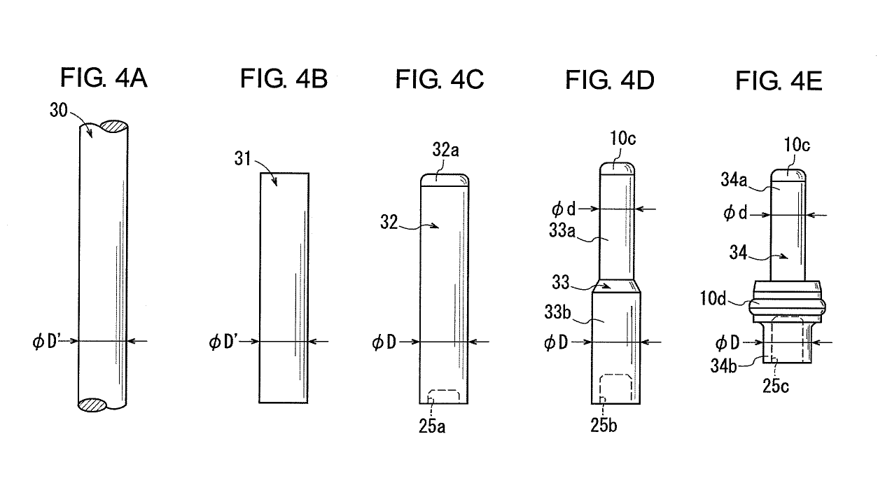

First, a rod 30, which has a diameter φD′ and a circular cross-section and is made of steel as conductive metal, is prepared as shown in FIG. 4A. A first workpiece 31 having a predetermined length as shown in FIG. 4B is obtained by cutting the rod 30 in the direction perpendicular to the axial direction.

### Second Step

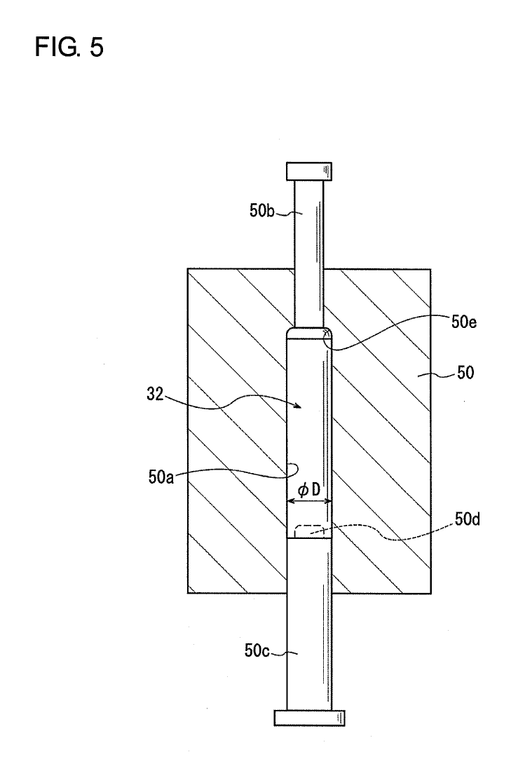

An end surface adjusting die 50, which has a cavity 50a as shown in FIG. 5, is prepared. The inner diameter of the cavity 50a is denoted by φD, and is slightly larger than φD′. The φD is substantially the same as the outer diameter of the large-diameter portion 10b of the pin terminal 10 shown in FIG. 2.

As shown in FIG. 5, a curved surface 50e is formed at the upper end of the cavity 50a. Further, a kickout pin 50b is provided at the upper end of the cavity 50a, and a punch 50c is provided at the lower end of the cavity 50a so as to be capable of applying pressure in the cavity 50a. A protrusion 50d having a first height is formed on the upper end surface of the punch 50c. Meanwhile, the first height is a height corresponding to a first depth.

Further, the first workpiece 31 is conveyed into the cavity 50a of the end surface adjusting die 50, and pressure is applied to the first workpiece 31 by the punch 50c. Accordingly, the rear end surface of the first workpiece 31 comes into pressure contact with the kickout pin 50b and the curved surface 50e, and the first workpiece 31 is adjusted and subjected to plastic working.

In this way, the first workpiece 31 is formed into a second workpiece 32 that includes a curved surface 32a at the rear end surface thereof as shown in FIG. 4C. For this reason, even though recesses and protrusions are formed on the rear end surface of the first workpiece or the end surface of the first workpiece is inclined when the first workpiece 31 is prepared, the recesses and protrusions do not expand by extruding or the like and the obtained second workpiece 32 is not unexpectedly deformed. Further, a first fitting recess 25a having the first depth is formed at the front end surface of the second workpiece 32 by the protrusion 50d.

After that, the punch 50c is moved down and the second workpiece 32 is taken out from the end surface adjusting die 50 by the kickout pin 50b.

### Third Step

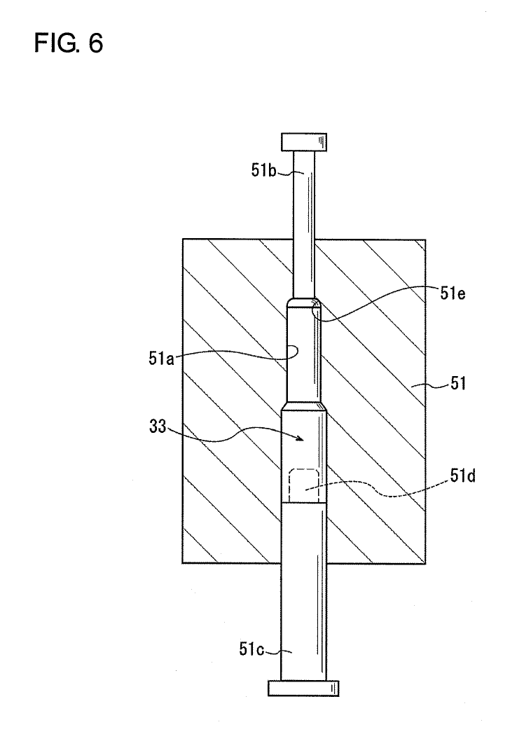

Then, an extrusion die 51, which has a cavity 51a having the upper portion formed so as to have a small diameter as shown in FIG. 6, is prepared.

A curved surface 51e is formed at the upper end of the cavity 51a. Further, a kickout pin 51b is provided at the upper end of the cavity 51a, and a punch 51c is provided at the lower end of the cavity 51a so as to be capable of applying pressure in the cavity 51a. A protrusion 51d, which has a second height larger than the first height, is formed on the upper end surface of the punch 51c. Meanwhile, the second height is a height corresponding to a second depth.

Further, the second workpiece 32 is conveyed into the cavity 51a of the extrusion die 51 so that the curved surface 32a faces upward, and pressure is applied to the second workpiece 32 by the punch 51c. Accordingly, the rear end surface of the second workpiece 32 comes into pressure contact with the kickout pin 51b and the curved surface 51e again, and the second workpiece 32 is adjusted and subjected to plastic working.

In this way, the second workpiece 32 is formed into a third workpiece 33 having the diameter which is reduced at the rear end portion thereof as shown in FIG. 4D. The rear end portion of the third workpiece 33 forms a small-diameter portion 33a having φd and the front end portion thereof forms a large-diameter portion 33b having φD larger than 4d. The diameter of the curved surface 32a is reduced, so that the end surface of the small-diameter portion 33a is formed into the curved surface 10c corresponding to the product shape. Further, a second fitting recess 25b, which has the second depth larger than the first depth, is formed at the front end surface of the third workpiece 33 by the protrusion 51d. After that, the punch 51c is moved down and the third workpiece 33 is taken out from the extrusion die 51 by the kickout pin 51b.

### Fourth Step

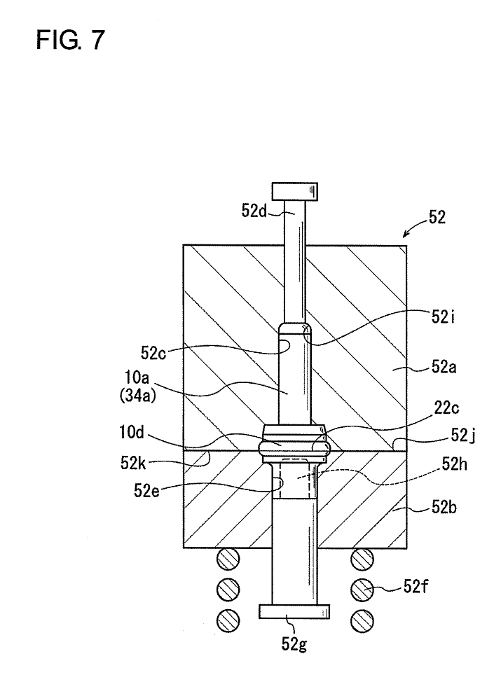

A flange forming die 52, which includes a first die 52a and a second die 52b as shown in FIG. 7, is prepared in a fourth step. The second die 52b is urged toward the first die 52a by a pressing spring 52f.

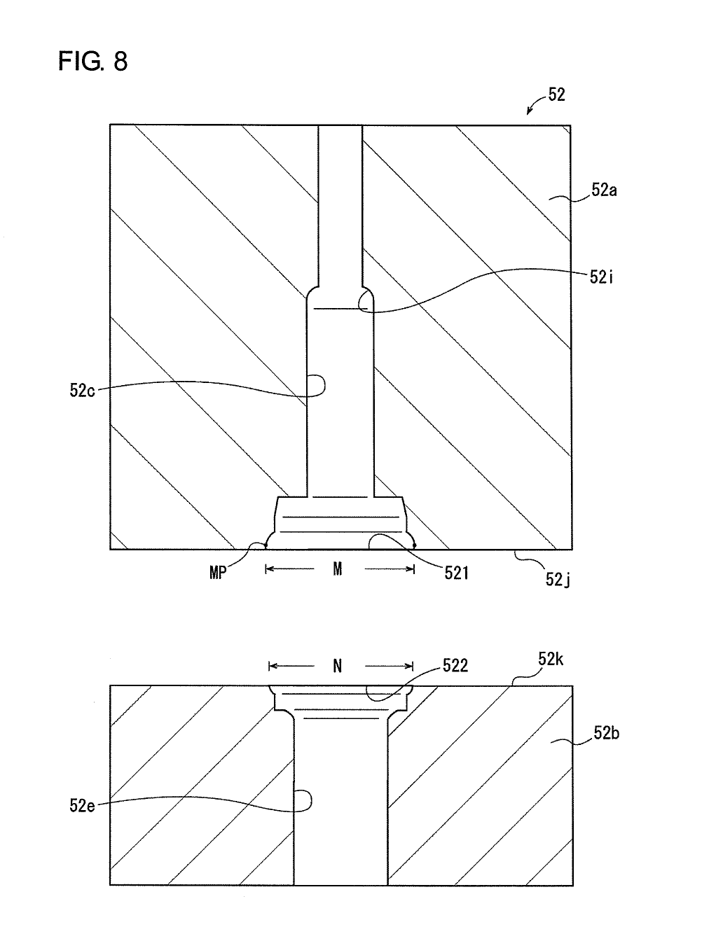

A first cavity 52c, which matches the small-diameter portion 10a, the tapered surface 20, the first cylindrical surface 21, and the first arc 22a of the convex curved surface 22 of the flange 10d shown in FIG. 2, is formed in the first die 52a as shown in FIG. 8. That is, a portion of the pin terminal, which is close to the rear end of the pin terminal from the first arc 22a of the flange 10d, can be formed by the first cavity 52c. Further, the first cavity 52c is formed so that the upper end of the small-diameter portion 33a is disposed in the first die 52a when the third workpiece 33 shown in FIG. 4D is disposed. Furthermore, a curved surface 52i is formed at the upper end of the first cavity 52c.

Meanwhile, a second cavity 52e, which matches the second cylindrical surface 23, the second arc 22b of the convex curved surface 22, and the large-diameter portion 10b of the flange 10d shown in FIG. 2, is formed in the second die 52b. That is, a portion of the pin terminal, which is close to the front end of the pin terminal from the second arc 22b of the flange 10d, can be formed by the second cavity 52e.

Here, as described above, the first arc 22a and the second arc 22b of the pin terminal 10 are formed on the rear and front sides of a portion, which is slightly at the side of the front end with respect to the maximum diameter position MP of the flange 10d, as a boundary, respectively (see FIG. 2B). That is, as shown in FIG. 8, mating surfaces 52j and 52k of the respective first and second cavities 52c and 52e of the first and second dies 52a and 52b are located at the side of the front end with respect to the maximum diameter position MP.

Further, a first round hole 521 matching the first arc 22a is formed on the mating surface 52j of the first die 52a. Likewise, a second round hole 522 matching the second arc 22b is formed on the mating surface 52k of the second die 52b. The maximum diameter N of the second round hole 522 is smaller than the maximum diameter M of the first round hole 521.

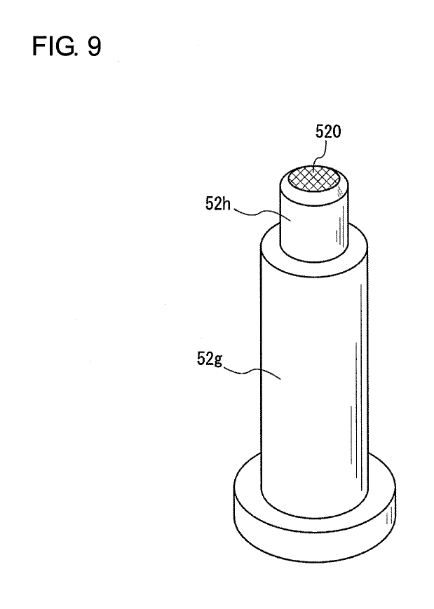

Furthermore, as shown in FIG. 7, a kickout pin 52d is provided at the upper end of the first cavity 52c. Meanwhile, a punch 52g is provided at the lower end of the second cavity 52e so as to be capable of applying pressure in the second cavity 52e. As shown in FIG. 9, a protrusion 52h, which has a third height larger than the second height, is formed on the upper end surface of the punch 52g. The third height is a height corresponding to a third depth, and more specifically, a height from the front end of the third workpiece 33 to a position corresponding to the second cylindrical surface 23 of the flange 10d. The protrusion 52h has a tapered shape where the diameter of the protrusion 52h is reduced toward an upper end surface 520 of the protrusion 52h. Further, knurling is performed on the upper end surface 520 of the protrusion 52h.

As shown in FIG. 7, the third workpiece 33 is conveyed into the first and second cavities 52c and 52e of the first and second dies 52a and 52b so that the small-diameter portion 33a is positioned on the upper side, that is, in the first die 52a, and pressure is applied to the third workpiece 33 by the punch 52g. Accordingly, the rear end surface of the third workpiece 33 comes into pressure contact with the kick-out pin 52d and the curved surface 52i, and the third workpiece 33 is adjusted and subjected to plastic working. In this way, the third workpiece 33 is formed into a fourth workpiece 34 as shown in FIG. 4E.

The rear end portion of the fourth workpiece 34 is a small-diameter portion 34a that is the same as the small-diameter portion 33a of the third workpiece 33. Further, the flange 10d is formed between a large-diameter portion 34b, which is the same as the large-diameter portion 33b of the third workpiece 33, and the small-diameter portion 34a. In this case, due to a difference between the maximum diameter M of the first round hole 521 of the first cavity 52c and the maximum diameter N of the second round hole 522 of the second cavity 52e, the step 22c is formed on the outer peripheral surface of the flange 10d at the portion slightly at the side of the front end with respect to the maximum diameter position MP. The step 22c has a shape where the step falls down toward the front end of the convex curved surface 22 (the front end of the fourth workpiece 34). Meanwhile, the end surface of the small-diameter portion 34a remains in the form of the curved surface 10c. Further, a third fitting recess 25c, which has a third depth larger than the second depth, is formed at the front end surface of the fourth workpiece 34 by the protrusion 52h.

After that, the punch 52g and the second die 52b are moved down and the fourth workpiece 34 is taken out from the flange forming die 52 by the kick-out pin 52d. Meanwhile, the small-diameter portion 34a formed at the fourth workpiece 34 corresponds to the small-diameter portion 10a shown in FIG. 2. Likewise, the large-diameter portion 34b formed at the fourth workpiece 34 corresponds to the large-diameter portion 10b shown in FIG. 2, and the third fitting recess 25c corresponds to the fitting recess 25 shown in FIG. 2.

### Outer Diameter Finishing Step

After that, the outer diameter finishing step of performing cutting by a cutter or the like is performed on the outer periphery of the fourth workpiece 34. Accordingly, it is possible to improve the roundness of the outer periphery of the flange 10d of the fourth workpiece 34 by cutting, for example, the outer periphery of the flange 10d. The pin terminal 10 shown in FIG. 2 is manufactured through the outer diameter finishing step. Meanwhile, it may be possible to perform the outer diameter finishing step by performing polishing using a grinder or the like instead of the cutting performed by a cutter or the like.

Meanwhile, the main body bracket 3, the heat generating tube 11, the insulating body 15, the heat generating coil 13, the center shaft 7, the O-ring 17, the insulator 19, and the like are prepared as shown in FIG. 1. Further, these are assembled with each other and the assembled-body is fitted to the pin terminal 10 by a commonly known method so that necessary portions of these are electrically connected to each other. In this case, while the rear end portion of the center shaft 7 is fitted to the fitting recess 25, the crimp formation region 10f (see FIG. 2A) of the pin terminal 10 is actually crimped at the rear end portion of the insulator 19. Accordingly, the center shaft 7 and the pin terminal 10 are jointed to each other as shown in FIGS. 1 and 10, so that assembly is completed. Further, a crimping portion 10g is formed on the outer peripheral surface of the large-diameter portion 10b, that is, the crimp formation region 10f. As shown in FIG. 10, the length β of the crimping portion 10g is set to a length that exceeds half of the overall length a of the crimp formation region 10f in the axial direction. Furthermore, when crimping is performed, a crimping position is adjusted so that the crimping portion 10g is positioned at the side of the front end with respect to the middle of the crimp formation region 10f in the axial direction, that is, is positioned close to the front end of the large-diameter portion 10b of the pin terminal 10. In this way, a glow plug is completed.

When male threads 3c of the main body bracket 3 are engaged with a cylinder head of a diesel engine, the heat generating portion 5a of the heater 5 of the glow plug, which is obtained in this way, is positioned in a combustion chamber of the diesel engine. Further, the main body bracket 3 is grounded to the cylinder head, and the cap 97a shown in FIG. 3 is fitted to the pin terminal 10.

When the cap 97a is press-fitted to the pin terminal 10 in the direction of an arrow shown in FIG. 3, the portion 971 to be locked is locked to the engagement portion 10e, so that the cap 97a is fitted to the pin terminal 10. In this state, the conductive member 87a is connected to the small-diameter portion 10a. Accordingly, electric power is supplied to the pin terminal 10, eventually, to the glow plug through the conductive member 87a.

Therefore, a voltage is applied between the main body bracket 3 and the pin terminal 10 and the center shaft 7, so that the heat generating portion 5a of the heater 5 generates heat by the heat generating coil 13. Accordingly, the diesel engine starts.

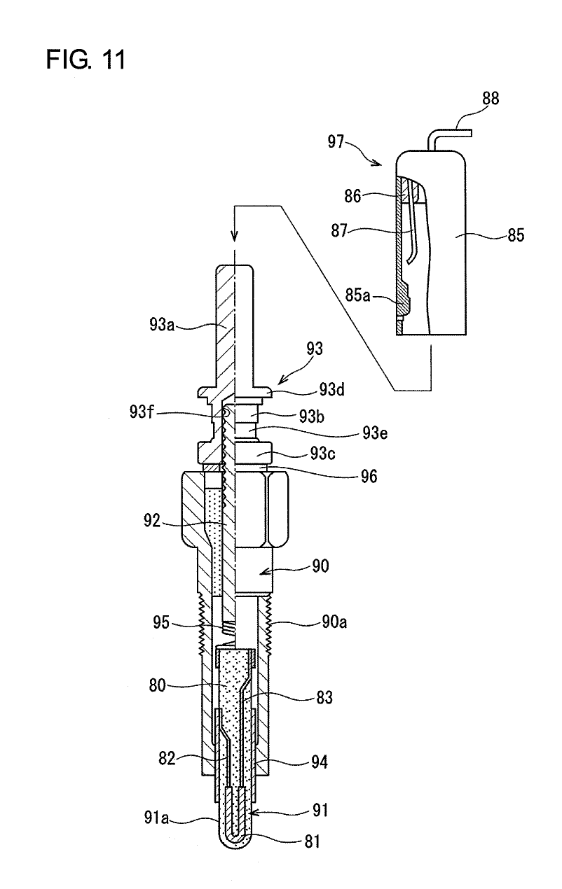

A first flange 93c, which is formed at a pin terminal 93 (see FIG. 11) of a glow plug in the related art, is not formed at the front end portion of the pin terminal 10 of the glow plug. For this reason, in the glow plug, as shown in FIGS. 1 and 10, the front end surface of the pin terminal 10, that is, the front end surface of the large-diameter portion 10b, comes into contact with the rear end surface of the insulator 19. Accordingly, the insulator 19 is pressed. Further, in this state, the insulator 19 presses the O-ring 17 at the front end thereof. For this reason, the O-ring 17 is elastically deformed in the shaft hole 3a, and the O-ring 17 comes into close contact with the center shaft 7, the insulator 19, and the wall surface of the shaft hole 3a. In this way, an insulation effect, which is caused between the center shaft 7 and the main body bracket 3 by the O-ring 17, is sufficiently provided in the glow plug.

Further, the first flange 93c is not formed as described above. Accordingly, as shown in FIG. 10, in the pin terminal 10, the overall length thereof is maintained, that is, the compatibility with the cap 97 fitted to the pin terminal 10 is maintained and the length of the crimp formation region 10f, which is formed so as to have the even diameter and can be crimped, (the overall length a of the crimp formation region 10f, which corresponds to a straight portion of the large-diameter portion 10b, in the axial direction) is large. For this reason, the center shaft 7 and the pin terminal 10 are easily and solidly joined to each other at the long crimp formation region 10f, and a slightly short center shaft 7 can be employed in the glow plug. Accordingly, the glow plug including the pin terminal 10 achieves a reduction in the amount of material and weight.

Further, the length β of the crimping portion 10g, when crimping has been actually performed, becomes a length that exceeds half of the overall length a of the crimp formation region 10f in the axial direction. For this reason, in the glow plug, the joint strength between the center shaft 7 and the pin terminal 10 is high as compared to a common product (see FIG. 11) where the length of a crimping portion is equal to or smaller than half of the overall length of a crimp formation region in the axial direction. Accordingly, the glow plug reliably provides excellent durability.

Moreover, as shown in FIG. 10, the crimping portion 10g is positioned at the side of the front end with respect to the middle of the crimp formation region 10f in the axial direction. For this reason, in the glow plug, crimping is performed on the pin terminal 10 at the position that is close to the front end of the large-diameter portion 10b. Accordingly, in the glow plug, it is possible to reduce a load applied to the rear end portion of the center shaft 7. As a result, the durability of the glow plug is further improved.

Accordingly, the glow plug provides excellent durability through the joining between the center shaft 7 and the pin terminal 10 with high joint strength, and can achieve a reduction in the amount of material and weight.

Particularly, the diameter of the front end surface of the large-diameter portion 10b of the pin terminal 10 of the glow plug is smaller than the diameter of the rear end surface of the insulator 19 of the glow plug. For this reason, it is possible to very reliably prevent current from leaking to the main body bracket 3 from the pin terminal 10.

Further, as shown in FIG. 2A, the fitting recess 25 of the pin terminal 10 of the glow plug includes the inner peripheral surface 251 that extends from the front end of the large-diameter portion 10b toward the rear end of the large-diameter portion and the upper bottom surface 252 that continues to the rear end of the inner peripheral surface 251 and is positioned inside the pin terminal in the radial direction between the engagement portion 10e and the flange 10d. Accordingly, as shown in FIG. 10, in the glow plug, it is possible to position the rear end portion of the center shaft 7, which is fitted to the fitting recess 25, at the rear of the crimping portion 10g formed at the crimp formation region 10f. For this reason, since crimping is performed at the side of the front end with respect to the rear end portion of the center shaft 7 in the glow plug, it is possible to more effectively prevent a load from being concentrated on the rear end portion of the center shaft 7. Accordingly, the durability of the center shaft 7 itself is improved and the durability of the glow plug itself is also improved.

Furthermore, since the upper bottom surface 252 has a tapered shape where the diameter of the upper bottom surface is reduced toward the rear end and the fitting recess 25 has the third depth in the pin terminal 10, the upper bottom surface 252 is positioned in the pin terminal 10 at the position corresponding to the second cylindrical surface 23. For this reason, in the fourth step of obtaining the pin terminal 10, the thickness of the periphery of the upper bottom surface 252 is increased at the third workpiece 33 in which the third fitting recess 25c is formed. Accordingly, it is difficult for the upper bottom surface of the third fitting recess 25c (which corresponds to the upper bottom surface 252 of the fitting recess 25) to be deformed even by plastic deformation when the flange 10d is formed, and it is difficult for distortion or the like to occur on the upper bottom surface 252. Moreover, plastic deformation of the third workpiece 33 reaches a maximum at the maximum diameter position MP of the flange 10d. However, since the upper bottom surface 252 is positioned at the side of the front end with respect to the maximum diameter position MP of the flange 10d, it is difficult for the deformation of the upper bottom surface 252, which is caused by plastic deformation, to occur on the obtained fourth workpiece 34. For these reasons, it is difficult for distortion or wrinkles or the like, which is generated by the distortion, to occur on the upper bottom surface 252 in the fourth workpiece 34, so that it is difficult for cleaning liquid or the like used during plating to remain on the upper bottom surface 252. Accordingly, plating is preferably performed on the fitting recess 25 in the pin terminal 10. Further, it is difficult for rust or the like to occur on the upper bottom surface 252 in the pin terminal 10.

Further, since knurling is performed on the upper end surface 520 of the protrusion 52h of the punch 52g, it is difficult for the protrusion 52h to slide in the second fitting recess 25b when pressure is applied to the third workpiece 33 by the punch 52g. Accordingly, it is possible to preferably form the third fitting recess 25c. For these reasons, the pin terminal 10 has high quality, and the quality of the glow plug eventually becomes high.

Furthermore, in the glow plug, the center shaft 7 has a tapered rear end portion having the diameter reduced toward the rear end and the rear end portion of the center shaft 7 is positioned inside the upper bottom surface 252. For this reason, when the pin terminal 10 and the center shaft 7 are assembled, the rear end of the center shaft 7 is easily inserted into the fitting recess 25 since the rear end portion of the center shaft 7 has the above-mentioned tapered shape. Moreover, the rear end of the center shaft 7 inserted into the fitting recess 25 reaches the upper bottom surface 252 along the inner peripheral surface 251. Accordingly, it is possible to preferably join the center shaft 7 to the pin terminal 10 with high joint strength so that the rear end portion of the center shaft 7 is positioned inside the upper bottom surface 252. For this reason, the durability of the glow plug is improved.

In addition, since the upper bottom surface 252 is positioned in the pin terminal 10 at the position corresponding to the second cylindrical surface 23 as described above, the depth of the fitting recess 25 is relatively small. For this reason, it is possible to make the rear end of the center shaft 7 short. Accordingly, the whole center shaft 7 can be formed to be short in the glow plug, so that it is possible to reduce the manufacturing cost of the glow plug. Meanwhile, even though the depth of the fitting recess 25 is reduced and the rear end of the center shaft 7 becomes short as described above, the joint strength between the center shaft 7 and the pin terminal 10 is maintained high since the length β of the crimping portion 10g is a sufficient length as shown in FIG. 10.

Further, the flange 10d includes the first cylindrical surface 21, the convex curved surface 22, and the second cylindrical surface 23. Furthermore, the flange 10d includes the first disc surface 21a, the tapered surface 20 that is connected to the first disc surface 21a and the first cylindrical surface 21, and the second disc surface 23a that is connected to the second cylindrical surface 23 and the large-diameter portion 10b. In addition, the step 22c is formed on the outer peripheral surface of the convex curved surface 22 of the flange 10d at the position slightly at the side of the front end with respect to the maximum diameter position MP.

For these reasons, the cap 97a is easily fitted to the pin terminal 10 and it is difficult for the cap 97a, which is locked to the engagement portion 10e, to be taken out from the pin terminal 10. Specifically, since the cap 97a is mounted on the pin terminal 10 while the cap 97a is press-fitted in the direction of the arrow shown in FIG. 3, the portion 971 to be locked of the cap main body 970 is elastically deformed so as to expand along the first disc surface 21a and the tapered surface 20 and reaches the convex curved surface 22. Further, the portion 971 to be locked is elastically deformed so as to further expand along the first arc 22a and reaches the maximum diameter position MP. While the portion 971 to be locked is elastically deformed so as to contract along the step 22c and the second arc 22b after passing the maximum diameter position MP, the portion 971 to be locked reaches the engagement portion 10e. Furthermore, the portion 971 to be locked is locked to the second cylindrical surface 23. Since the mounting direction of the cap 97a on the pin terminal 10 is along the tapered surface 20 and the first arc 22a as described above, it is possible to easily fit the cap 97a to the pin terminal 10.

Meanwhile, even though the portion 971 to be locked is deviated from the second cylindrical surface 23 due to the vibration and the like of a diesel engine and is moved in the direction where the cap 97a is taken out from the pin terminal 10, that is, the direction opposite to the arrow shown in FIG. 3, the portion 971 to be locked is caught by the step 22c and is locked to the step 22c as it is. Accordingly, for example, even though the engagement of the portion 971 to be locked caused by the second cylindrical surface 23 is released and the portion 971 to be locked is elastically deformed so as to expand along the second arc 22b, the portion 971 to be locked comes into contact with the step 22c. For this reason, the portion 971 to be locked does not expand larger than the second arc 22b and cannot reach the first arc 22a beyond the step 22c. As a result, the portion 971 to be locked is locked to the step 22c. Since the cap 97a is doubly locked by the second cylindrical surface 23 and the step 22c in the glow plug as described above, it is possible to more preferably fit the cap 97a to the pin terminal 10.

In addition, in the fourth step, the step 22c is formed using a difference between the maximum diameter M of the first round hole 521 of the first cavity 52c and the maximum diameter N of the second round hole 522 of the second cavity 52e. For this reason, it is possible to suppress the generation of swarf of the fourth workpiece 34 as compared to, for example, the case where the step 22c is formed by cutting the entire outer peripheral surface of the convex curved surface 22.

The embodiment of the invention has been described above. However, the invention is not limited to the above-mentioned embodiment, and it goes without saying that the invention may be appropriately modified without departing from the scope of the invention.

For example, a housing made of a resin may be employed in the glow plug instead of the main body bracket 3.

Further, the heat generating tube 11, the insulating powder 12, and the heat generating coil 13 have been used as the heater 5 in the above-mentioned embodiment. However, a ceramic heater may be used as the heater.

Furthermore, as described above, the step 22, the second cylindrical surface 23, and the second disc surface 23a form the engagement portion 10e, and the portion 971 to be locked may be locked by these. In this case, it is more difficult for the portion 971, which is to be locked, to be taken out from the engagement portion 10e, so that it is more difficult for the cap 97a to be taken out from the pin terminal 10e.

Moreover, the punches 50c and 51c may have the same structure as the structure of the punch 52g except for the lengths of the protrusions 50d and 51d. In this case, even when the first and second fitting recesses 25a and 25b are formed, it is difficult for the protrusions 50d and 51d to slide on the first and second workpieces 31 and 32 due to knurling that is performed on each of the upper end surfaces of the protrusions 50d and 51d. Accordingly, it is possible to preferably form the first and second fitting recesses 25a and 25b.

In addition, the step 22c may not be formed by the plastic working of the fourth step and may be formed by cutting when an outline finishing step is performed on the fourth workpiece 34.

### REFERENCE SIGNS LIST

87: conductive member
10a: small-diameter portion
10d: flange
25: fitting recess
10b: large-diameter portion
MP: maximum diameter position
10e: engagement portion
10: pin terminal
10f: crimp formation region
19: insulator (insulating member)
251: inner peripheral surface
252: upper bottom surface
3: main body bracket (housing)
5a: heat generating portion
5: heater
7: center shaft
17: O-ring
10g: crimping portion
251: inner peripheral surface
252: upper bottom surface
21: first cylindrical surface
22: convex curved surface
23: second cylindrical surface
22c: step
21a: first disc surface
20: tapered surface
23a: second disc surface

Having described the invention, the following is claimed:

1. A pin terminal for a glow plug comprising:
a small-diameter portion which has a shaft shape extending in an axial direction and is to be connected to a conductive member for supplying electric power from an outside;
a flange that is formed integrally with a front end of the small-diameter portion and is formed so as to have an outer diameter larger than an outer diameter of the small-diameter portion;
a cylindrical large-diameter portion that is formed integrally with a front end of the flange so as to be shorter than the small-diameter portion in the axial direction, is formed so as to have an outer diameter larger than the outer diameter of the small-diameter portion and smaller than the outer diameter of the flange, and includes a fitting recess formed therein in a radial direction so as to be recessed toward a rear end of the large-diameter portion from a front end of the large-diameter portion in the axial direction; and
an engagement portion which is positioned between a maximum diameter position of the flange and the large-diameter portion and has an outer diameter gradually reduced toward the large-diameter portion,
wherein the large-diameter portion includes a crimp formation region which is formed in a range from a front end of the large-diameter portion to a front end of the engagement portion so as to have an even outer diameter and be capable of being crimped.

2. The pin terminal according to claim 1, wherein a diameter of a front end surface of the large-diameter portion is smaller than that of a rear end surface of an insulating member which is a component of the glow plug.

3. The pin terminal according to claim 1, wherein the fitting recess includes an inner peripheral surface that extends from the front end of the large-diameter portion toward the rear end of the large-diameter portion, and an upper bottom surface that continues to a rear end of the inner peripheral surface and is positioned inside the engagement portion or the flange in a radial direction of the engagement portion or the flange.

4. The pin terminal according to claim 3, wherein the upper bottom surface has a tapered shape where a diameter of the upper bottom surface is reduced toward a rear end thereof.

5. The pin terminal according to claim 4, wherein the upper bottom surface is positioned at a side of the front end of the flange with respect to the maximum diameter position of the flange.

6. The pin terminal according to claim 1, wherein
the flange includes a first cylindrical surface that is positioned close to the small-diameter portion and has a diameter larger than the diameter of the small-diameter portion, a convex curved surface which is connected to the first cylindrical surface and of which a cross-section in the axial direction forms an arc and a cross-section in a direction perpendicular to the axial direction of which has a circular shape, and a second cylindrical surface that is connected to the convex curved surface and has the same diameter as the diameter of the first cylindrical surface, and
a step is formed on the convex curved surface at a side of the second cylindrical surface with respect to the maximum diameter position.

7. The pin terminal according to claim 6,
wherein the flange includes a first disc surface that is connected to the small-diameter portion, a tapered surface which is connected to the first disc surface and is tapered toward a rear end side thereof, and a second disc surface that connects the second disc surface to the large-diameter portion and extends in the direction perpendicular to the axial direction.

8. A glow plug comprising:
a cylindrical housing;
a heater that is fixed in the housing and includes a heat generating portion protruding from a front end of the housing;
a rod-like center shaft which is disposed in the housing and includes a rear end portion protruding from a rear end of the housing;
an insulating member which is provided at the rear end of the housing and into which the center shaft is inserted; and
a pin terminal that is fitted to the rear end portion of the center shaft and used for supplying electricity to the heat generating portion from an outside through the center shaft,
wherein the pin terminal includes:
a small-diameter portion which has a shaft shape extending in an axial direction and is to be connected to a conductive member for supplying electric power from the outside;
a flange that is formed integrally with a front end of the small-diameter portion and is formed so as to have an outer diameter larger than an outer diameter of the small-diameter portion;
a cylindrical large-diameter portion that is formed integrally with a front end of the flange so as to be shorter than the small-diameter portion in the axial direction, is formed so as to have an outer diameter larger than the outer diameter of the small-diameter portion and smaller than the outer diameter of the flange, and includes a fitting recess formed therein in a radial direction so as to be recessed toward a rear end of the large-diameter portion from a front end of the large-diameter portion in the axial direction; and
an engagement portion which is positioned between a maximum diameter position of the flange and the large-diameter portion and has an outer diameter gradually reduced toward the large-diameter portion,
wherein the large-diameter portion includes a crimp formation region which is formed in a range from a front end of the large-diameter portion to a front end of the engagement portion so as to have an even outer diameter and be capable of being crimped, and
wherein a part of the crimp formation region forms a crimping portion that fixes the rear end portion of the center shaft by crimping.

9. The glow plug according to claim 8, wherein the crimping portion has a length that exceeds a half of an overall length of the crimp formation region in the axial direction.

10. The glow plug according to claim 9, wherein the crimping portion is positioned at a side of a front end of the crimp formation region with respect to a middle of the crimp formation region in the axial direction.

11. The glow plug according to claim 8, wherein the fitting recess includes an inner peripheral surface that extends from a front end of the large-diameter portion toward a rear end of the large-diameter portion, and an upper bottom surface that continues to a rear end of the inner peripheral surface and is positioned inside the engagement portion or the flange in a radial direction of the engagement portion or the flange,
the upper bottom surface has a tapered shape where a diameter of the upper bottom surface is reduced toward a rear end,
the center shaft has a tapered rear end portion having a diameter reduced toward a rear end, and
the rear end portion of the center shaft is positioned inside the upper bottom surface.

12. The glow plug according to claim 10, wherein the upper bottom surface is positioned at the side of the front end with respect to the maximum diameter position of the flange.
